(19) United States
(12) Patent Application Publication
(10) Pub. No.: US 2005/0207638 A1
(43) Pub. Date: Sep. 22, 2005

(54) System and method for automatically transferring a defect image from an inspection system to a database

(76) Inventor: Roy Eric Staveley, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/133,702

(22) Filed: May 20, 2005

Related U.S. Application Data
(63) Continuation of application No. PCT/US03/37496, filed on Nov. 20, 2003.
(60) Provisional application No. 60/428,110, filed on Nov. 21, 2002.

(51) Int. Cl. G06K 9/00

(52) U.S. Cl. 382/145

(57) ABSTRACT

A system and method for automatically transferring a defect image from an inspection system to a database are disclosed. The method includes identifying a defect on a lithography component loaded into an inspection system and capturing an image of the identified defect. An operator is prompted to select a defect code for the identified defect and the captured image is automatically transferred to a database in response to the operator selecting the defect code.

### RELATED APPLICATION

This application is a continuation of PCT/US 03/37496, entitled “System and Method for Automatically Transferring a Defect Image from an Inspection System to a Database” filed by Roy Eric Staveley on Nov. 20, 2003, which claims the benefit of U.S. Provisional Patent Application Ser. No. 60/428,110, entitled “Method for Automatically Transferring an Image of a Defect on a Photomask from an Inspection System to a Database” filed by Roy Eric Staveley on Nov. 21, 2002.

### TECHNICAL FIELD OF THE INVENTION

The present invention relates in general to photolithography and, more particularly to a system and method for transferring a defect image from an inspection system to a database.

### BACKGROUND OF THE INVENTION

As semiconductor manufacturers continue to produce smaller devices, the requirements for photomasks used in fabrication of these devices continue to tighten. Photomasks, also known as reticles or masks, typically include a substrate having a non-transmissive or partially transmissive layer formed on one surface of the substrate. The non-transmissive or partially transmissive layer typically includes a pattern representing an image that may be transferred onto a semiconductor wafer in a lithography system. As feature sizes of the semiconductor devices decrease, the corresponding images on the photomask also become smaller and more complex. Consequently, the quality of photomasks has become one of the most crucial elements in establishing a robust and reliable semiconductor fabrication process.

During a photomask manufacturing process, the photomask is generally placed in an inspection system to determine if any defects are present. If a defect is identified on the photomask, the defect may be cataloged in a centralized database so that others in the company or manufacturing facility may access data associated with the defect. The process of capturing an image of the defect and placing it in the centralized database often requires a significant amount of operator time. The operator must manually capture and save the image on the inspection system by giving the saved file a unique name. The operator repeats the capture and save steps for each defect identified during a quality review session. The operator then removes the photomask from the inspection system and moves to a separate computer to transfer the captured image information to the database. At the computer, the operator manually keys in identification information for the photomask and must remember the unique file names for each identified defect.

Conventional processes, such as the one described above, require an operator to perform all of the steps. Each time a new defect is captured, the operator may need between three and five minutes to capture, save, convert and transfer the image. This labor intensive process wastes time and money and may decrease productivity of a photomask manufacturing facility.

### SUMMARY OF THE INVENTION

In accordance with teachings of the present invention, disadvantages and problems associated with transferring a defect image from an inspection system to a database have been substantially reduced or eliminated. In a particular embodiment, a method for transferring a defect image from an inspection system to a database includes selecting a defect code to initiate an automatic transfer of a captured defect image and related description information.

In accordance with one embodiment of the present invention, a method for transferring a defect image from an inspection system to a database includes identifying a defect on a lithography component loaded into an inspection system and capturing an image of the identified defect. An operator of the inspection system is prompted to select a defect code for the identified defect and the captured image is automatically transferred to a database in response to the operator selecting the defect code.

In accordance with another embodiment of the present invention, a method for transferring a defect image from an inspection system to a database includes loading a photomask into an inspection system and extracting description information associated with the photomask. A defect on the photomask is identified and an image of the identified defect is captured from a display device. The description information is associated with the captured image and an operator of the inspection system is prompted to select a defect code for the identified defect. The method continues by automatically transferring the captured image and the description information to a database in response to the operator selecting the defect code.

In accordance with a further embodiment of the present invention, a system for transferring an image of a defect to a database includes a processor coupled to a computer readable memory. Processing instructions are encoded in the computer readable memory. The instructions are executed by the processor to identify a defect on a lithography component loaded into an inspection system and capture an image of the identified defect. The instructions prompt an operator to select a defect code for the identified defect and automatically transfer the captured image to a database in response to the operator selecting the defect code.

Important technical advantages of certain embodiments of the present invention include a capture module that automatically extracts information about a photomask from an inspection system. During an inspection process, the photomask may be loaded into the inspection system and description information associated with the photomask may be saved in a memory. When a defect is identified, the capture module collects the description information for the respective photomask from the memory and associates the description information with a captured image of the defect. Automatic extraction of the description information reduces the amount of time needed to collect information related to defect images and also reduces potential operator error.

Another important technical advantage of certain embodiments of the present invention includes a capture module that allows an operator to associate a defect code with an identified defect. Before a captured image is transferred to a database, the capture module prompts an operator at an inspection system to select a defect code for the identified defect. The capture module automatically associates the defect code with description information for the photomask and transfers the description information, defect code and captured image to the database. The defect code provides a technique for cataloging the identified defect before sending the image to the database.

All, some, or none of these technical advantages may be present in various embodiments of the present invention. Other technical advantages will be readily apparent to one skilled in the art from the following figures, descriptions, and claims.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 illustrates a cross-sectional view of a photomask inspected in accordance with teachings of the present invention;

FIG. 2 illustrates a block diagram of a computer system for transferring an image of a defect from an inspection system to a database in accordance with teachings of the present invention;

FIG. 3 illustrates an example embodiment of a user interface on an inspection system for selecting a defect code in accordance with teachings of the present invention; and

FIG. 4 illustrates a flow chart of a method for transferring an image of a defect on a photomask from an inspection system to a database in accordance with teachings of the present invention.

### DETAILED DESCRIPTION OF THE INVENTION

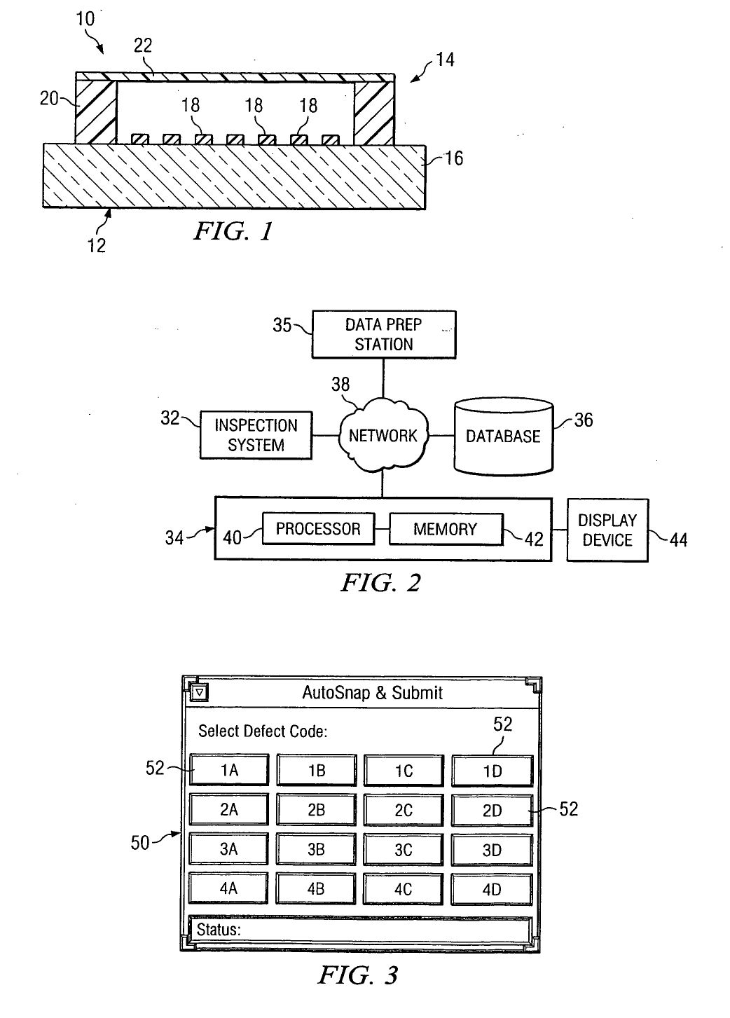

Preferred embodiments of the present invention and their advantages are best understood by reference to FIGS. 1 through 4, where like numbers are used to indicate like and corresponding parts.

FIG. 1 illustrates a cross-sectional view of photomask assembly 10 that may be inspected by automatically transferring a defect image from an inspection system to a database. Photomask assembly 10 includes photomask 12 coupled to pellicle assembly 14. Substrate 16 and patterned layer 18 cooperate with each other to form portions of photomask 12. Photomask 12 may also be described as a mask or reticle and may have a variety of sizes and shapes, including but not limited to round, circular, rectangular, or square. Photomask 12 may also be any variety of photomask types, including, but not limited to, a one-time master, a five-inch reticle, a six-inch reticle, a nine-inch reticle or any other appropriately sized reticle that may be used to project an image of a circuit pattern onto a semiconductor wafer. Photomask 12 may further be a binary mask, a phase shift mask (PSM), an optical proximity correction (OPC) mask or any other type of mask suitable for use in a lithography system.

Photomask 12 includes patterned layer 18 formed on substrate 16 that, when exposed to electromagnetic energy in a lithography system, projects a pattern onto a surface of a semiconductor wafer (not expressly shown). Substrate 16 may be a transparent material such as quartz, synthetic quartz, fused silica, magnesium fluoride (MgF₂), calcium fluoride (CaF₂), or any other suitable material that transmits at least seventy-five percent (75%) of incident light having a wavelength between approximately 10 nanometers (nm) and approximately 450 nm. In an alternative embodiment, substrate 16 may be a reflective material such as silicon or any other suitable material that reflects greater than approximately fifty percent (50%) of incident light having a wavelength between approximately 10 nm and 450 nm.

Patterned layer 18 may be a metal material such as chrome, chromium nitride, a metallic oxy-carbo-nitride (M-O—C—N), where the metal is selected from the group consisting of chromium, cobalt, iron, zinc, molybdenum, niobium, tantalum, titanium, tungsten, aluminum, magnesium and silicon, or any other suitable material that absorbs electromagnetic energy with wavelengths in the ultraviolet (UW) range, deep ultraviolet (DUV) range, vacuum ultraviolet (VUV) range and extreme ultraviolet range (EUV). In an alternative embodiment, patterned layer 18 may be a partially transmissive material, such as molybdenum silicide (MoSi), which has a transmissivity of approximately one percent (1%) to approximately thirty percent (30%) in the UV, DUV, VUV and EUV ranges.

Frame 20 and pellicle film 22 may form pellicle assembly 14. Frame 20 is typically formed of anodized aluminum, although it may alternatively be formed of stainless steel, plastic or other suitable materials that do not degrade or outgas when exposed to electromagnetic energy within a lithography system. Pellicle film 22 may be a thin film membrane formed of a material such as nitrocellulose, cellulose acetate, an amorphous fluoropolymer, such as TEFLON® AF manufactured by E. I. du Pont de Nemours and Company or CYTOP® manufactured by Asahi Glass, or another suitable film that is transparent to wavelengths in the UV, DUV, EUV and/or VUV ranges. Pellicle film 22 may be prepared by conventional techniques such as spin casting.

Pellicle film 22 protects photomask 12 from contaminants, such as dust particles, by ensuring that the contaminants remain a defined distance away from photomask 12. This may be especially important in a lithography system. During a lithography process, photomask assembly 10 is exposed to electromagnetic energy produced by a radiant energy source within the lithography system. The electromagnetic energy may include light of various wavelengths, such as wavelengths approximately between the I-line and G-line of a Mercury arc lamp, or DUV, VUV or EUV light. Pellicle film 22 is preferably designed to allow a large percentage of the electromagnetic energy to pass therethrough. Contaminants collected on pellicle film 22 will likely be out of focus at the surface of a wafer being processed and, therefore, an exposed image on the wafer will generally be clear of any defects associated with pellicle film 22. Pellicle film 22 and photomask 12 may be satisfactorily used with all types of electromagnetic energy and are not limited to lightwaves described in this application.

Photomask 12 may be formed from a photomask blank using a standard lithography process. In a lithography process, a mask pattern file that includes data for patterned layer 18 may be generated from a mask layout file. The mask layout file may include polygons that represent transistors and electrical connections for an integrated circuit. The polygons in the mask layout file may further represent different layers of the integrated circuit when fabricated on a semiconductor wafer. For example, a transistor may be formed on a semiconductor wafer with a diffusion layer and a polysilicon layer. The mask layout file may include one or more polygons drawn on the diffusion layer and one or more polygons drawn on the polysilicon layer. The polygons for each layer may be converted into a mask pattern file that represents one layer of the integrated circuit. Each mask pattern file may be used to generate a photomask for the specific layer.

The desired pattern may be imaged into a resist layer of the photomask blank using a laser, electron beam, or X-ray lithography system. In one embodiment, a laser lithography system uses an Argon-Ion laser that emits light having a wavelength of approximately 364 nanometers (nm). In alternative embodiments, the laser lithography system may use lasers emitting light at wavelengths from approximately 150 nm to approximately 300 nm. Photomask 12 may be fabricated by developing and etching exposed areas of the resist layer to create a pattern, etching portions of patterned layer 18 not covered by resist, and removing any undeveloped resist to create patterned layer 18 over substrate 16.

A photomask may be a crucial component of a lithography system because it serves as the template that images a complex geometry, such as an integrated circuit (IC), on a wafer. Before photomask 12 is delivered to a customer, an inspection system may be used to identify any defects on photomask 12. When photomask 12 is loaded into the inspection system, information may be extracted from photomask 12 and stored in a memory on the inspection system as description information for photomask 12. If a defect is identified by the inspection system, an operator may determine whether to capture and store an image of the identified defect in a centralized database for others in the company or manufacturing facility to view. In one embodiment, the centralized database may include previously collected defect images and the corresponding description information associated with a particular photomask.

If the operator chooses to transfer the image to the database, the inspection system captures the image of the defect and creates a file that includes description information associated with photomask 12. The inspection system may then prompt the operator to select a defect code for the identified defect. The operator selects the appropriate code and the inspection system associates the defect code with the captured image and the photomask description information. The inspection system then transfers the captured image and the associated description file to a centralized database. The capture and transfer process may be fully automated such that the operator of the inspection system only selects a defect code for the identified defect after the image is captured by the inspection system. Once the image and associated description information are stored in the database, other operators, technicians, or engineers that have access to the database may view the stored image and associated description information.

FIG. 2 illustrates a block diagram of a communication system, indicated generally at 30, for transferring an image of a defect from an inspection system to a database. In the illustrated embodiment, system 30 includes inspection system 32, computer system 34, data prep station 35 and database 36 coupled to network 38. In one embodiment, inspection system 32 may identify a defect on a photomask. Computer system 34 may capture an image of the identified defect and prompt an operator at inspection system 32 to select a defect code for the identified defect. Once a defect code is selected, inspection system 32, computer system 34 and/or data prep station 35 associates the defect code with description information for the photomask and computer system 34 and/or data prep station 35 transfers the description information and the captured image to database 36 via network 38. The entire process is completely automated and, therefore, reduces the amount of time required to capture and store a defect image in database 36.

Although a specific communication network is illustrated in FIG. 1, the term “network” should be interpreted as generically defining any network capable of transmitting telecommunication signals, data and/or messages. Network 38 represents any suitable collection and arrangement of communications equipment supporting the transport and delivery of packets, cells, or other portions of information (generally referred to as packets). For example, network 38 may be one or a collection of components associated with the public switched telephone network (PSTN), a local area network (LAN), a wide area network (WAN), a global computer network such as the Internet, or any other communications equipment suitable for providing wireless and/or wireline communications.

Inspection system 32 may detect defects on numerous types of photomasks, including, but not limited to, binary masks, PSMs and OPC masks and/or numerous types of semiconductor wafers, including but not limited to, silicon wafers and gallium arsenide wafers. In one embodiment, inspection system 32 may be a STARlight™ inspection system manufactured and sold by KLA-Tencor. Data prep station 35 may be any system used to convert mask layout files received from customers into mask pattern files used to fabricate photomask. The mask pattern file additionally may be used by inspection system 32 to determine if defects exist on a lithography component, such as photomask 12, by comparing the features in the mask pattern file with the features formed in patterned layer 18 of photomask 12. Although data prep station 35 is shown as communicating with network 38, data prep station 35 may also be directly interfaced with inspection system 32.

Computer system 34 may include processor 40, memory 42 and display device 44. Processor 40 may be a microprocessor, a microcontroller, a digital signal processor (DSP) or any other digital or analog circuitry configured to execute processing instructions stored in memory 42. Memory 42 may be random access memory (RAM), electrically erasable programmable read-only memory (EEPROM), a PCMCIA card, flash memory, or any suitable selection and/or array of volatile or non-volatile memory that retains data after the power to computer system 34 is turned off. Display device 44 may be a liquid crystal device, cathode ray tube, or other display device suitable for creating graphic images and alphanumeric characters recognizable to a user. Although computer system 34 is shown as communicating with inspection system 32 through network 38, computer system 34 may also be integral to or directly interfaced with inspection system 32.

In operation, processing instructions are stored in memory 42. Processor 40 accesses memory 42 to retrieve the processing instructions and perform various functions included in the processing instructions. In one embodiment, the processing instructions may include a capture module and a submit module. The capture module may retrieve an image of a defect on a lithography component (e.g., a photomask or semiconductor wafer) from inspection system 32. The capture module may initially store the image on inspection system 32 and/or memory 42 in computer system 34. In one embodiment, the image may be displayed on inspection system 32 and/or display device 44. In another embodiment, the image may be displayed on data prep station 35 by accessing memory 42. The capture module may also retrieve description information for the lithography component from inspection system 32. In one embodiment, the image description information may be loaded into inspection system 32 and/or computer system 34 when an image of a lithography component is loaded into inspection system 32. In another embodiment, the image description information may additionally be loaded into data prep station 35 during an inspection process or at the end of an inspection process.

Once the capture module has retrieved the image and the image description information from inspection system 32, the capture module then prompts an operator at inspection system 32 and/or data prep station 35 to select a defect code for the identified defect. In one embodiment, the operator may be located at inspection system 32 during an inspection process. In this example, the lithography component may be loaded into inspection system 32 during the inspection process. In another embodiment, the operator may be located at data prep station 35 after completion of an inspection process. In this example, the operator may assign a defect code to the identified defects associated with the lithography component after the lithography component has been removed from inspection system 32.

In one embodiment, the prompt displayed to the operator may be a graphical user interface (GUI) displayed on inspection system 32, display device 44 and/or data prep station 35. Once the operator selects a defect code, a submit module associates the selected defect code with the image description information and sends the image and description information to database 36. In another embodiment, the image description information and associated image may be transferred to an image database server (not expressly shown) for processing, cataloging and viewing in database 36. Database 36 may be integral to the image database server, coupled to the image database server via network 38 or directly interfaced with the image database server. Once the image and description files are received at database 36, the files are processed, and the image file and annotation data obtained from the image description file are inserted into the database. After a successful transfer, the captured image and description file are then removed from inspection system 32 and/or computer system 34.

In one embodiment, a log file may include a record of each time the submit module attempts to transfer the captured image to database 36. If the transfer is unsuccessful, the log file may indicate that the captured image and associated description file were not transferred to database 36. At a predefined time interval, the submit module may access the log file to determine if any files are waiting to be transferred. In one embodiment, the predefined time interval may be between approximately five minutes and approximately twenty minutes. If the log file contains a message that at least one transfer was interrupted, the submit module attempts to transfer the image and places a successful transfer message in the log file once the captured image and description file have been successfully transferred. In one embodiment, messages in the log file that indicate a successful transfer was achieved may be periodically removed so that the size of the log file is reduced.

In other embodiments, the processing instructions for transferring an image of a defect from an inspection system to a database may be encoded in computer-usable media. Such computer-usable media may include, without limitation, storage media such as floppy disks, hard disks, CD-ROMs, DVDs, read-only memory, and random access memory; as well as communications media such wires, optical fibers, microwaves, radio waves, and other electromagnetic or optical carriers.

FIG. 3 illustrates a user interface for selecting a defect code associated with an identified defect that may be displayed on inspection system 32, display device 44 and/or data prep station 35. In the illustrated embodiment, defect interface 50 may include buttons 52 that represent various defect codes for the types of defects that may be found on a lithography component, such as photomask 12. The defect codes may be any combination of alphanumeric characters, any graphical symbols or any other suitable code that represents a type of defect. In an example inspection system, code 1A may represent isolated material (e.g., chrome or MoSi) and code 4D may represent a false defect as identified by the operator. Other defects may include, but are not limited to, contaminants on substrate 16 and/or patterned layer 18, distorted feature geometry caused by a bad repair, missing material (e.g., chrome or MoSi) on a feature edge, pinholes in patterned layer 18, corner defects and missing features in patterned layer 18, and scratches, pits and bubbles on substrate 16. In other embodiments, fewer than or more than sixteen defect types may be identified by inspection system 32.

Defect interface 50 may include the appropriate number of buttons 52 to represent the number of defect types identifiable by inspection system 32. The operator may click or double click using a mouse to select one of buttons 50, or use any other suitable method to select the appropriate defect code for the identified defect. In another embodiment, the defect codes may be entered manually on a keyboard, selected from a pull down menu or selected using any other suitable technique.

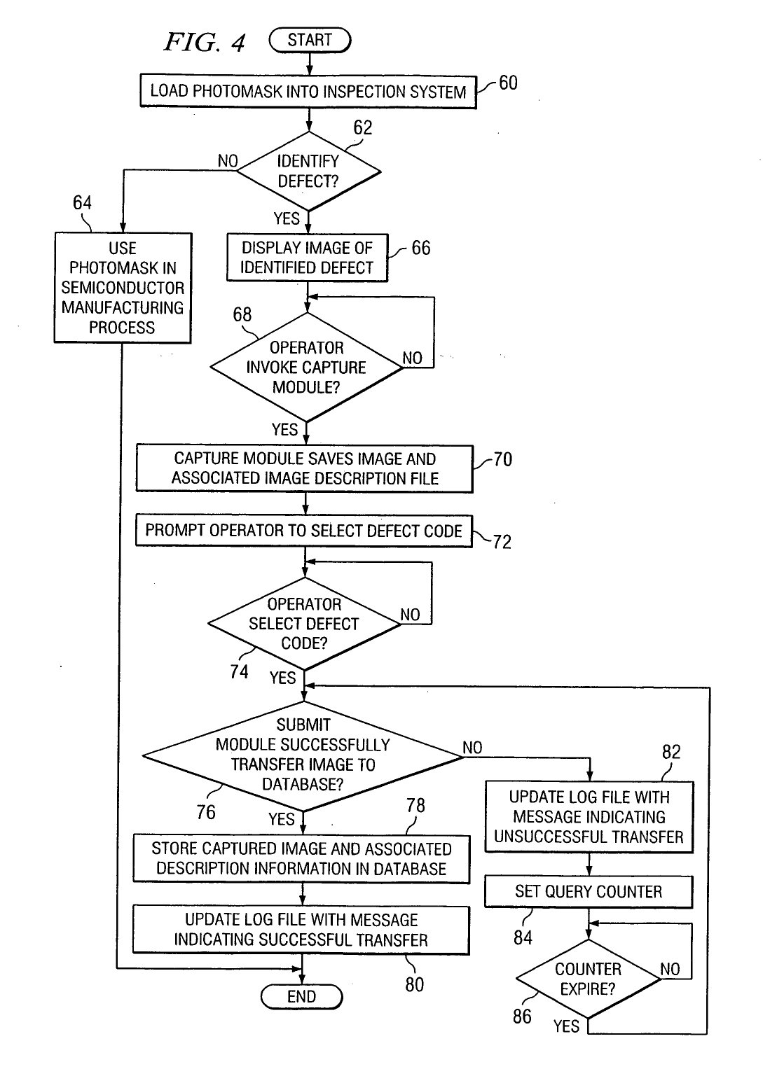

FIG. 4 illustrates a flow chart of a method for transferring a defect image from an inspection system to a database. Generally, an inspection system identifies a defect on a lithography component, such as a photomask or a semiconductor wafer. An operator at the inspection system initiates a capture and submit process to capture an image of the defect. A capture module saves the image on the inspection system and creates a description file that includes description information for the lithography component being inspected. The capture module then prompts an operator to enter a defect code for the identified defect. Once the defect code is selected, a submit module associates the defect code with the image description file and submits the captured image and associated description file to a database. The captured image and description file are then stored in the database such that they may be accessed through any system that has access to the network.

At step 60, a lithography component, such as photomask 12, may be placed into inspection system 32 in order to inspect substrate 16 and patterned layer 18 for defects. In one embodiment, description information associated with photomask 12 may be extracted and placed in an image description file. The description information may include, but is not limited to, job number, layer name, customer name, device name, operator ID, tool name, date, time and site name. Job number may be a unique identifier containing, for example, alphanumeric characters that represent the inspection process being performed on photomask 12. Layer name may represent the layer (e.g., diffusion, polysilicon, via or metal) of a microelectronic device that photomask 12 is used to image onto a semiconductor wafer. Customer name may represent a specific customer that ordered a photomask to be manufactured. Device name may be a unique identifier supplied by a specific customer that represents a purpose for a photomask in the customer's manufacturing process. Operator ID may be the initials of the operator using the inspection system or any other suitable type of identifier that may uniquely represent an individual operator. Tool name may include alphanumeric characters that represent the type of inspection system and/or manufacturer model name for the system. Site name may be a unique identifier for the manufacturing location.

At step 62, inspection system 32 scans photomask 12 for defects. If inspection system 32 does not detect any defects, photomask 12 may be shipped to a customer and used in a semiconductor manufacturing process at step 64. If a defect is identified, an image of the defect is displayed on inspection system 32, display device 44 and/or data prep station 35 at step 66. The operator may then choose to save the image and transfer the image to database 36 by invoking a capture module at step 68. In one embodiment, the operator may click on an icon or other graphical representation on inspection system 32 or computer system 34. In other embodiment, the operator may manually type a command on a keyboard or select the process from a pull down menu. The image may be displayed on inspection system 32, display device 44 and/or data prep station 35 until the operator chooses to save the image, moves to inspect another defect on photomask 12 or removes photomask 12 from inspection system 32.

If the operator chooses to transfer the image, the capture module saves a representation of the image in an image file, extracts the description information provided when photomask is loaded into inspection system 32 and saves the description information in an image description file at step 70. In one embodiment, the description file may be an ASCII text file and each field (e.g., job number, layer name, etc.) may be separated by a comma. At step 72, the capture module may prompt the operator to select a defect code by displaying a graphical user interface (GUI) on inspection system 32, display device 44 and/or data prep station 35. In one embodiment, the GUI may include buttons that represent different defect codes for specific types of defects. The operator may select a defect code by clicking, double clicking or otherwise selecting the button for the defect code associated with the identified defect at step 74.

Once the operator selects the appropriate defect code, a submit module attempts to transfer the image file and the image description file to database 36 at step 76. After selecting the defect code, the operator may move to another defect on photomask 12 or remove photomask 12 from inspection system 32. If the files are transferred successfully, database 36 stores the captured image and the associated description file in an appropriate database location at step 78. In one embodiment, the operator may additionally choose to save the image file and the associated description file on a database located at a specific manufacturing facility. If the information is stored in database 36, the operator may be notified that the transfer was successful. The defect image and its associated information may then be accessed by any system coupled to network 38. The submit module then updates a log file with a message that the image and associated description information was successfully stored in database 36 at step 80. In one embodiment, the submit module may also remove the stored image file and the image description file from inspection system 32 and/or computer system 34.

If the transfer attempt is not successful because, for example, inspection system 32 and/or computer system 34 loses power or network 38 experiences a failure, the submit module may update the log file with a message that the transfer attempt was not successful at step 82. In one embodiment, the submit module may also monitor the size of the log file and remove any messages indicating that the transfer was successful in order to decrease the size of the log file. At step 84, the submit module may initiate a counter. The counter may represent the amount of time between attempts to transfer the data in the log file to database 36. In one embodiment, the counter may have a duration between approximately five minutes and approximately twenty minutes. The submit module monitors the counter to determine if the counter has expired at step 84. If the counter has expired, the submit module locates the image file and image description file using the message in the log file and attempts to submit the files to database 36 at step 78. The submit module continues to transfer the image file and associated description file in database 36 until the files are successfully stored in database 36.

Although the present invention has been described with respect to a specific preferred embodiment thereof, various changes and modifications may be suggested to one skilled in the art and it is intended that the present invention encompass such changes and modifications fall within the scope of the appended claims.

1. A method for transferring a defect image from an inspection system to a database, comprising:
identifying a defect on a lithography component loaded into an inspection system;
capturing an image of the identified defect;
prompting an operator to select a defect code for the identified defect; and
automatically transferring the captured image to a database in response to the operator selecting the defect code.

2. The method of claim 1, further comprising extracting description information associated with the lithography component.

3. The method of claim 2, further comprising:
associating the description information with the captured image; and
automatically transferring the description information and the captured image to the database.

4. The method of claim 2, wherein the description information comprises one or more of a customer name, a job number, a layer name, a device name, a site name, a tool serial number, an operator identifier and the defect code.

5. The method of claim 1, further comprising notifying the operator if the captured image was stored in the database.

6. The method of claim 1, further comprising:
creating a log file associated with the captured image; and
writing a message in the log file indicating that a transfer of the captured image from the inspection system to the database was attempted.

7. The method of claim 6, further comprising the message indicating a successful transfer if the captured image is stored in the database.

8. The method of claim 6, further comprising the message indicating an unsuccessful transfer if an error occurs during the transfer attempt.

9. The method of claim 1, wherein the lithography component comprises a photomask.

10. The method of claim 1, wherein the lithography component comprises a wafer.

11. The method of claim 1, further comprising the defect code including one or more alpha numeric characters.

12. A method for transferring a defect image from an inspection system to a database, comprising:
loading a photomask into an inspection system;
extracting description information associated with the photomask;
identifying a defect on the photomask;
capturing an image of the identified defect from a display device;
associating the description information with the captured image;
prompting an operator of the inspection system to select a defect code for the identified defect; and
automatically transferring the captured image and the description information to a database in response to the operator selecting the defect code.

13. The method of claim 12, wherein the description information comprises one or more of a customer name, a job number, a layer name, a device name, a site name, a tool serial number, an operator identifier and the defect code.

14. The method of claim 12, further comprising:
creating a log file associated with the captured image; and
writing a message in the log file indicating that the captured image was stored in the database.

15. The method of claim 12, further comprising:
creating a log file associated with the captured image;
writing-a message in the log file indicating that an error occurred during the transfer; and
storing the captured image and the description information in a memory associated with the inspection system in response to detecting the error until the captured image and the description information are stored in the database.

16. A computer system for transferring a defect image from an inspection system to a database, comprising:
a processing resource;
a computer readable memory; and
processing instructions encoded in the computer readable memory, the processing instructions, when executed by the processing resource, operable to perform operations comprising:
identifying a defect on a lithography component loaded into an inspection system;
capturing an image of the identified defect;
prompting an operator to select a defect code for the identified defect; and
automatically transferring the captured image to a database in response to the operator selecting the defect code.

17. The system of claim 16, further comprising the processing instructions operable to perform instructions including extracting description information associated with the photomask.

18. The system of claim 17, further comprising the processing instructions operable to perform instructions including:
associating the description information with the captured image; and
automatically transferring the description information and the captured image to the database.

19. The system of claim 16, further comprising the processing instructions operable to perform instructions including notifying the operator that the captured image was stored in the database.

20. The system of claim 16, further comprising the processing instructions operable to perform instructions including:
creating a log file associated with the captured image; and
writing a message in the log file indicating that the captured image was stored in the database.

21. The system of claim 16, further comprising the processing instructions operable to perform instructions including:
creating a log file associated with the captured image;
writing a message in the log file indicating that an error occurred during the transfer; and
storing the captured image and the description information in a memory associated with the inspection system in response to detecting the error until the captured image and the description information are stored in the database.

22. Software for transferring a defect image from an inspection system to a database, the software being embodied in computer-readable media and when executed operable to:
identify a defect on a lithography component loaded into an inspection system;
capture an image of the identified defect;
prompt an operator to select a defect code for the identified defect; and
automatically transfer the captured image to a database in response to the operator selecting the defect code.

23. The software of claim 22, further operable to extract description information associated with the photomask.

24. The software of claim 23, further operable to:
associate the description information with the captured image; and
automatically store the description information and the captured image in the database.

25. The software of claim 22, further operable to notify the operator that the captured image was stored in the database.

26. The software of claim 22, further operable to:
create a log file associated with the captured image; and
write a message in the log file indicating that the captured image was stored in the database.

27. The software of claim 22, further operable to:
create a log file associated with the captured image;
write a message in the log file indicating that an error occurred during the transfer; and
store the captured image and the description information in a memory associated with the inspection system in response to detecting the error until the captured image and the description information are stored in the database.
